(19) United States
(12) Patent Application Publication
(10) Pub. No.: US 2026/0323199 A1
(43) Pub. Date: Oct. 15, 2026

(54) WEARABLE ELECTRONIC DEVICE COMPRISING OPENING/CLOSING DEVICE

(71) Applicant: Samsung Electronics Co., Ltd., Suwon-si (KR)

(72) Inventors: Hangil MOON, Suwon-si (KR); Brian HAN, Suwon-si (KR); Kyoungho BANG, Suwon-si (KR); Gunwoo LEE, Suwon-si (KR)

(21) Appl. No.: 19/699,662

(22) Filed: Jun. 5, 2026

Related U.S. Application Data
(63) Continuation of application No. PCT/KR2024/019667, filed on Dec. 4, 2024.

(30) Foreign Application Priority Data
Dec. 5, 2023 (KR) 10-2023-0174780
Jan. 2, 2024 (KR) 10-2024-0000404

(51) Int. Cl. H04R 1/10; H04R 1/08

(52) U.S. Cl. CPC H04R 1/1041; H04R 1/086; H04R 1/1091; H04R 1/1016

(57) ABSTRACT

A wearable electronic device is provided. The wearable electronic device includes a speaker, a microphone spaced apart from the speaker, a housing accommodating the speaker and the microphone, and including an output passage configured to transfer a sound output from the speaker and a sound passage configured to transfer a sound received by the microphone, an opening device configured to close or open at least a portion of the sound passage, a detecting device configured to sense information related to the sound received by the microphone, at least one processor, and memory for storing instructions configured to, when executed by the at least one processor, cause the wearable electronic device to control the opening device based on the information sensed by the detecting device.

### CROSS-REFERENCE TO RELATED APPLICATION(S)

This application is a continuation application, claiming priority under 35 U.S.C. § 365(c), of an International application No. PCT/KR 2024/019667, filed on Dec. 4, 2024, which is based on and claims the benefit of a Korean patent application number 10-2023-0174780, filed on Dec. 5, 2023, in the Ministry of Intellectual Property (MOIP), and of a Korean patent application number 10-2024-0000404, filed on Jan. 2, 2024, in the Ministry of Intellectual Property (MOIP), the disclosure of each of which is incorporated by reference herein in its entirety.

### BACKGROUND

### 1. Field

The disclosure relates to a wearable electronic device. More particularly, the disclosure relates to a wearable electronic device including an opening device.

### 2. Description of Related Art

With the development of electronic technology, various types of wearable electronic devices are being miniaturized and have various functions.

One or more components related to an acoustic effect may be disposed on the printed circuit board of a wearable electronic device. The components related to the acoustic effect may include, for example, a speaker and a microphone. These components may be disposed inside the housing of the wearable electronic device with various shapes and arrangement structures corresponding to the various exterior designs of the wearable electronic device.

A wearable electronic device including a speaker and a microphone may be, for example, an in-ear earphone (or an earset, a headphone, a headset) or a hearing aid. The wearable electronic device may be worn in proximity to a user's ear and may be manufactured in a compact size for this purpose.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device including an opening device.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a speaker, a microphone spaced apart from the speaker, a housing accommodating the speaker and the microphone, and including an output passage configured to transmit a sound output from the speaker and a sound passage configured to transfer a sound received by the microphone, an opening device configured to open and close at least a portion of the sound passage, a detecting device configured to sense information related to the sound received through the microphone, at least one processor, and memory storing instructions, configured to, when executed by the at least one processor, cause the wearable electronic device to control the opening device, based on the information sensed by the detection device.

In accordance with another aspect of the disclosure, a method of operating a wearable electronic device is provided. The method includes outputting sound through a speaker while an acoustic passage formed inside a housing accommodating the speaker is in an open state, sensing information on sound received through a microphone disposed inside the housing, and controlling an opening device configured to close the acoustic passage, based on the information on the sound received through the microphone.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above or other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an audio module according to an embodiment of the disclosure;

FIG. 3A is a perspective view of a wearable electronic device according to an embodiment of the disclosure;

FIG. 3B is a perspective view of a wearable electronic device according to an embodiment of the disclosure;

FIG. 3C is a diagram illustrating the wearing of a wearable electronic device according to an embodiment of the disclosure;

FIG. 4 illustrates a portion of a wearable electronic device according to an embodiment of the disclosure;

FIG. 5 is a partial cross-sectional view of a wearable electronic device according to an embodiment of the disclosure;

FIG. 6A is a partial cross-sectional view of a wearable electronic device according to an embodiment of the disclosure;

FIG. 6B is a partial cross-sectional view of a wearable electronic device according to an embodiment of the disclosure;

FIG. 7 is a block diagram illustrating the transmission of sound according to an embodiment of the disclosure;

FIG. 8A is a conceptual diagram of a first state of an opening device according to an embodiment of the disclosure;

FIG. 8B is a conceptual diagram of a second state of the opening device according to an embodiment of the disclosure;

FIG. 8C is a conceptual diagram of a third state of an opening device according to an embodiment of the disclosure;

FIG. 9A is a conceptual diagram illustrating the operation of an opening device according to an embodiment of the disclosure;

FIG. 9B is a conceptual diagram illustrating the operation of an opening device according to an embodiment of the disclosure;

FIG. 9C is a conceptual diagram illustrating an operation of an opening device according to an embodiment of the disclosure;

FIG. 10 is a block diagram illustrating a relationship between components of a wearable electronic device according to an embodiment of the disclosure;

FIG. 11 is a block diagram illustrating a method for operating a wearable electronic device according to an embodiment of the disclosure;

FIG. 12 is a control block diagram of a wearable electronic device according to an embodiment of the disclosure;

FIG. 13 is a control block diagram of a wearable electronic device according to an embodiment of the disclosure;

FIG. 14 is a control block diagram of a wearable electronic device according to an embodiment of the disclosure;

FIG. 15 is a graph illustrating the effect of a wearable electronic device according to an embodiment of the disclosure;

FIG. 16A is a graph illustrating the effect of a wearable electronic device according to an embodiment;

FIG. 16B is a graph illustrating the effect of a wearable electronic device according to an embodiment of the disclosure;

FIG. 17 is a graph illustrating the effect of a wearable electronic device according to an embodiment of the disclosure; and

FIG. 18 is a graph illustrating the effect of a wearable electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

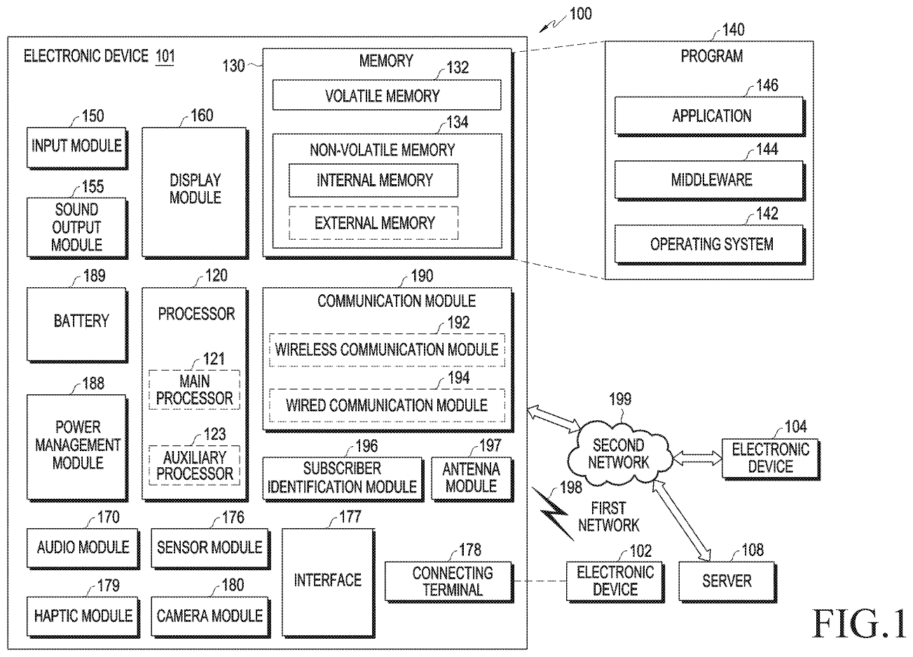

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

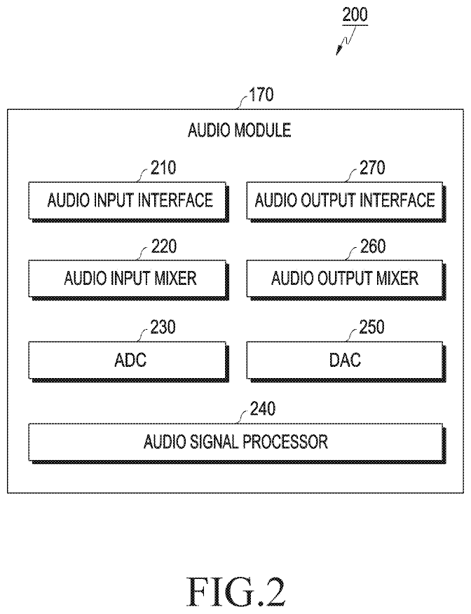

FIG. 2 is a block diagram of an audio module according to an embodiment of the disclosure.

Referring to FIG. 2, a block diagram 200 of an audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to sound acquired from the outside of the electronic device 101 through a microphone (e.g., a dynamic microphone, a condenser microphone, or a piezoelectric microphone) that is a part of the input module 150 or configured separately from the electronic device 101. For example, when the audio signal is acquired from an external electronic device 102 (e.g., a headset or a microphone), the audio input interface 210 may receive the audio signal by being connected to the external electronic device 102 directly through the connection terminal 178, or wirelessly through the wireless communication module 192 (e.g., via Bluetooth communication). According to an embodiment, the audio input interface 210 may receive a control signal (e.g., a volume adjustment signal received through the input button) related to the audio signal acquired from the external electronic device 102. The audio input interface 210 may include multiple audio input channels, and may receive a different audio signal for each corresponding audio input channel among the multiple audio input channels. According to an embodiment, additionally or alternatively, the audio input interface 210 may receive an audio signal from another component (e.g., the processor 120 or the memory 130) of the electronic device 101.

The audio input mixer 220 may mix multiple input audio signals into at least one audio signal. According to an embodiment, the audio input mixer 220 may mix multiple analog audio signals input through the audio input interface 210 into at least one analog audio signal.

The ADC 230 may convert an analog audio signal into a digital audio signal. According to an embodiment, the ADC 230 may convert an analog audio signal received through the audio input interface 210, or alternatively or additionally an analog audio signal mixed through the audio input mixer 220, into a digital audio signal.

The audio signal processor 240 may perform various types of processing on a digital audio signal received from the ADC 230 or on a digital audio signal received from another component of the electronic device 101. According to an embodiment, the audio signal processor 240 may perform, with respect to one or more digital audio signals, sampling rate conversion, application of one or more filters, interpolation processing, amplification or attenuation of the entire or partial frequency band, noise processing (e.g., noise or echo attenuation), channel change (e.g., switching between mono and stereo), mixing, or extraction of a designated signal. According to an embodiment, one or more functions of the audio signal processor 240 may be implemented in the form of an equalizer.

The DAC 250 may convert a digital audio signal into an analog audio signal. According to an embodiment, the DAC 250 may convert a digital audio signal processed by the audio signal processor 240 or a digital audio signal acquired from another component (e.g., the processor 120 or the memory 130) of the electronic device 101 into an analog audio signal.

The audio output mixer 260 may mix multiple audio signals to be output into at least one audio signal. According to an embodiment, the audio output mixer 260 may mix an audio signal converted into an analog signal through the DAC 250 and another analog audio signal (e.g., an analog audio signal received through the audio input interface 210) into at least one analog audio signal.

The audio output interface 270 may output an analog audio signal converted through the DAC 250, or additionally or alternatively an analog audio signal mixed by the audio output mixer 260, to the outside of the electronic device 101 through the sound output module 155. The sound output module 155 may include, for example, a speaker such as a dynamic driver or a balanced armature driver, or a receiver. According to an embodiment, the sound output module 155 may include multiple speakers. In this case, the audio output interface 270 may output an audio signal having multiple channels (e.g., stereo or 5.1 channels) through at least some of the multiple speakers. According to an embodiment, the audio output interface 270 may be connected to the external electronic device 102 (e.g., an external speaker or a headset) directly through a connection terminal 178 or wirelessly through the wireless communication module 192 to output an audio signal.

According to an embodiment, the audio module 170 may generate at least one digital audio signal by mixing multiple digital audio signals by using at least one function of the audio signal processor 240, without separately including the audio input mixer 220 or the audio output mixer 260.

According to an embodiment, the audio module 170 may include an audio amplifier (not shown) (e.g., a speaker amplifier circuit) capable of amplifying an analog audio signal input through the audio input interface 210 or an audio signal to be output through the audio output interface 270. According to an embodiment, the audio amplifier may be configured as a module separate from the audio module 170.

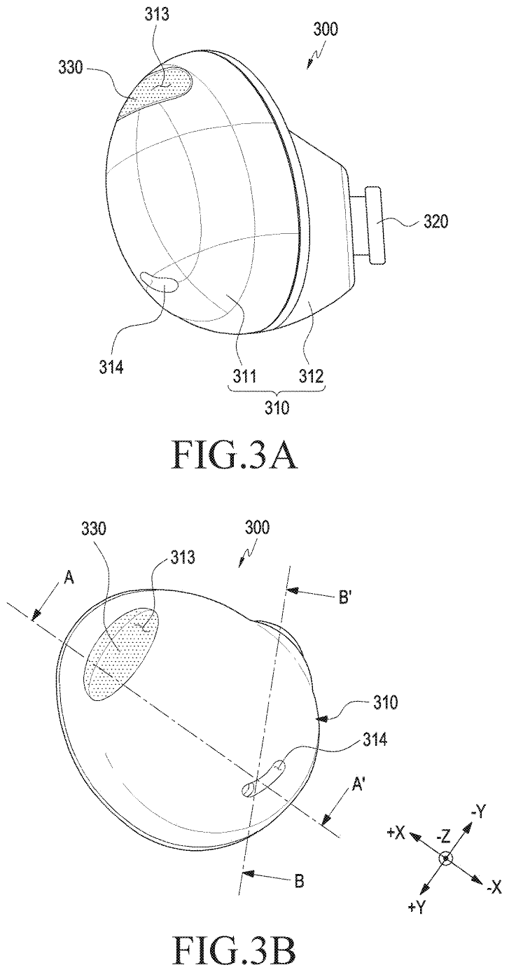

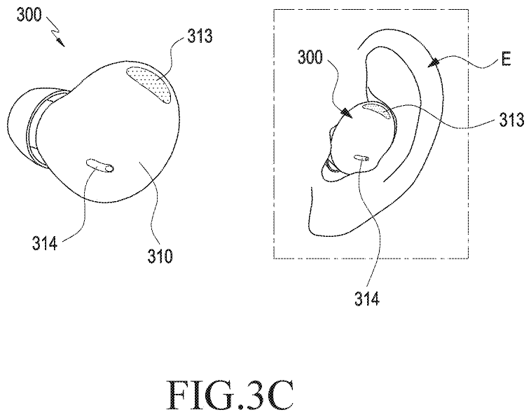

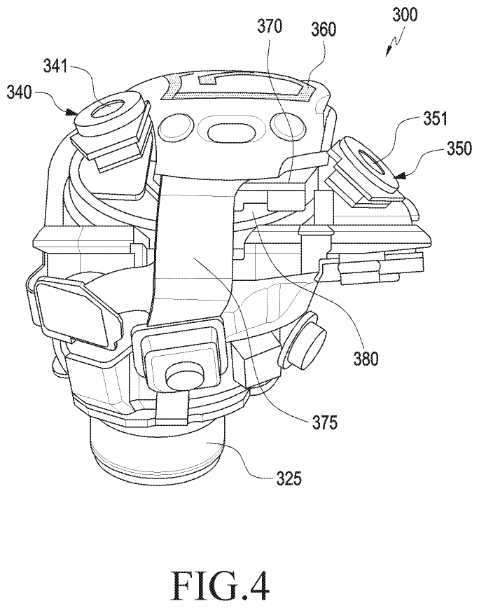

FIG. 3A is a perspective view of a wearable electronic device viewed from one direction according to an embodiment of the disclosure. FIG. 3B is a perspective view of the wearable electronic device viewed from a direction different from that of FIG. 3A according to an embodiment of the disclosure. FIG. 3C is a view illustrating the wearable electronic device in a worn state according to an embodiment of the disclosure. The components to be described with reference to FIGS. 3A to 3C may be partially or entirely identical to the components described with reference to FIGS. 1 and 2. The components to be described with reference to FIGS. 3A to 3C may be partially or entirely identical to the components to be described with reference to FIGS. 4, 5, 6A, 6B, 7, 8A to 8C, 9A to 9C, 10 to 15, 16A, 16B, 17, and 18.

According to an embodiment, a wearable electronic device 300 may include a housing 310. The housing 310 may form the exterior of the wearable electronic device 300. The housing 310 may be worn in a user's ear. For example, at least a portion of the housing 310 may have a curved surface.

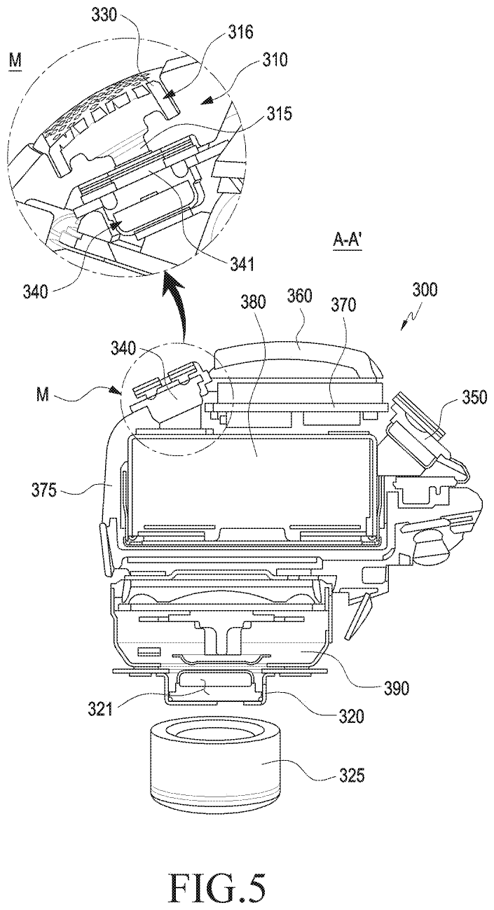

According to an embodiment, the housing 310 may include a first housing 311. The housing 310 may include a second housing 312. For example, the first housing 311 and the second housing 312 may be integrally formed. For example, an antenna (e.g., the antenna 360 in FIG. 5), a first substrate (e.g., the first substrate 370 in FIG. 5), a battery (e.g., the battery 380 in FIG. 5), and/or a microphone (e.g., the microphones 340 and 350 in FIG. 5) may be disposed inside the first housing 311. For example, a speaker (e.g., the speaker 390 in FIG. 5) may be disposed inside the second housing 312.

According to an embodiment, the wearable electronic device 300 may include a port 320. For example, the port 320 may protrude to the outside of the housing 310. For example, the port 320 may be integrally formed with the second housing 312. For example, the port 320 may be coupled to the second housing 312. Sound output from the speaker (e.g., the speaker 390 in FIG. 5) may be transmitted to the outside of the housing 310 through the port 320.

According to an embodiment, the housing 310 may include openings 313 and 314. The openings 313 and 314 may be formed through the surface of the housing 310. The openings 313 and 314 may be formed in the first housing 311. Sound outside the housing 310 may be transmitted into the housing 310 through the openings 313 and 314.

According to an embodiment, the wearable electronic device 300 may include a grill 330. The grill 330 may be disposed on the opening 313. The grill 330 may be coupled to the housing 310. The grill 330 may filter out impurities entering the opening 313.

According to an embodiment, there may be multiple openings 313 and 314. For example, the multiple openings 313 and 314 may include a first opening 313 and a second opening 314. The first opening 313 and the second opening 314 may be spaced apart from each other. Each of the first opening 313 and the second opening 314 may be referred to as an “opening.”

According to an embodiment, the wearable electronic device 300 may be worn in a user's ear E. In a state in which the wearable electronic device 300 is worn in the user's ear E, the openings 313 and 314 may be exposed to the outside.

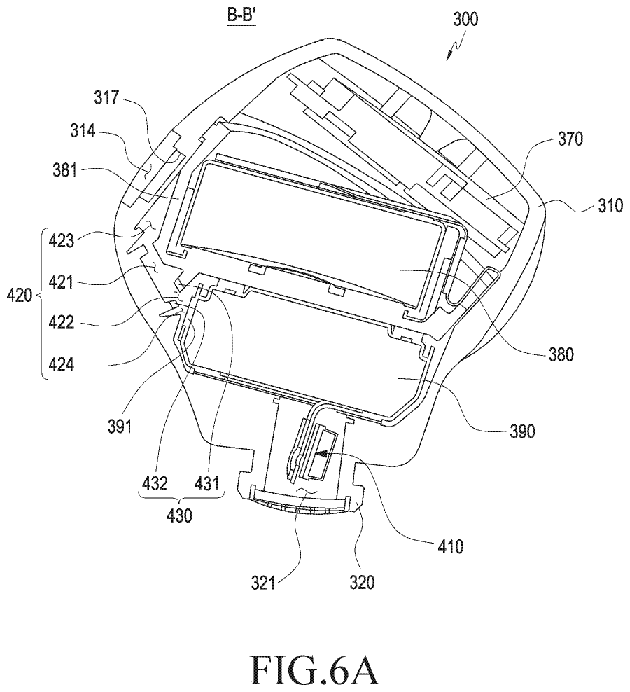

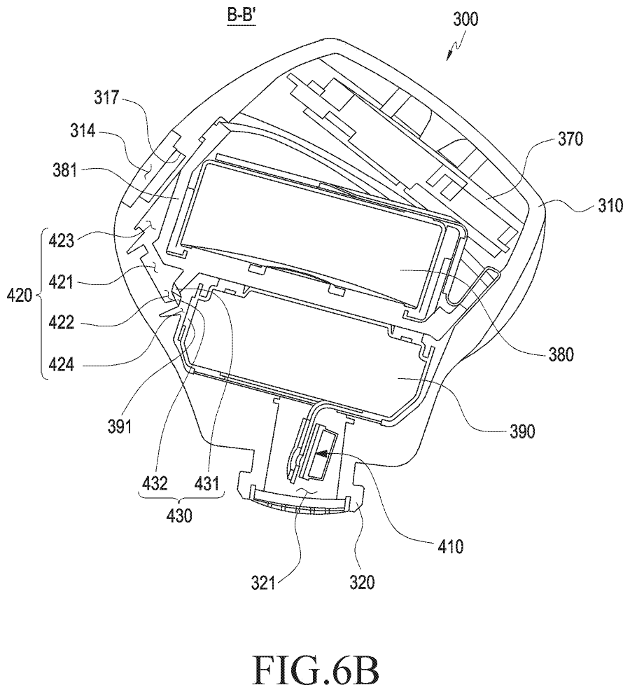

FIG. 4 illustrates a state in which a housing (e.g., the housing 310 in FIG. 3A) of a wearable electronic device is removed according to an embodiment of the disclosure. FIG. 5 is a cross-sectional view of the structure illustrated in FIG. 4 according to an embodiment of the disclosure. The components to be described with reference to FIGS. 4 and 5 may be partially or entirely identical to the components described with reference to FIGS. 1, 2, and 3A to 3C. The components to be described with reference to FIGS. 4 and 5 may be partially or entirely identical to the components to be described with reference to FIGS. 6A, 6B, 7, 8A to 8C, 9A to 9C, 10 to 15, 16A, 16B, 17, and 18.

According to an embodiment, a wearable electronic device 300 may include a microphone 340 or 350. In an embodiment, multiple microphones 340 and 350 may be arranged. For example, the microphones 340 and 350 may include a first microphone 340 and/or a second microphone 350. The first microphone 340 and the second microphone 350 may be spaced apart from each other. The first microphone 340 and the second microphone 350 may be referred to as a “microphone.” The microphones 340 and 350 may receive sound from outside a housing (e.g., the housing 310 in FIG. 3A). For example, the microphones 340 and 350 may perform an active noise cancellation (ANC) function. For example, the microphones 340 and 350 may be disposed inside the first housing (e.g., the first housing 311 in FIG. 3A). The microphones 340 and 350 may include microphone holes 341 and 351, respectively. The first microphone 340 may include a first microphone hole 341. The second microphone 350 may include a second microphone hole 351. The microphones 340 and 350 may receive sound from outside the housing (e.g., the housing 310 in FIG. 3A) through the microphone holes 341 and 351. For example, air (e.g., wind) flowing outside the housing (e.g., the housing 310 in FIG. 3A) may be introduced into the microphones 340 and 350 through the microphone holes 341 and 351, and the microphones 340 and 350 may detect sound generated by the flow of the air.

According to an embodiment, the microphone 340 may receive sound from outside the housing 310. Region M illustrated in FIG. 5 is an enlarged view of the area near the microphone 340 in a cross-sectional view of the wearable electronic device 300 including the housing 310. The wearable electronic device 300 may include a chamber 316. The housing 310 may be coupled to the grill 330. The wearable electronic device 300 may include a hole 315 communicating with the microphone hole 341 of the microphone 340. Sound outside the housing 310 may be received by the microphone 340 through the chamber 316 and the hole 315.

According to an embodiment, the wearable electronic device 300 may include an antenna 360. The antenna 360 may be disposed inside a first housing (e.g., the first housing 311 in FIG. 3A). The antenna 360 may transmit and/or receive a signal in the housing (e.g., the housing 310 in FIG. 3A).

According to an embodiment, the wearable electronic device 300 may include a first substrate 370. For example, the first substrate 370 may be electrically connected to the microphones 340 and 350, the antenna 360, a second substrate 375, a battery 380, and/or a speaker 390.

According to an embodiment, the wearable electronic device 300 may include the second substrate 375. The second substrate 375 may be electrically connected to the first substrate 370. For example, the second substrate 375 may connect the first substrate 370 to the microphones 340 and 350. For example, the second substrate 375 may connect the first substrate 370 to the battery 380. For example, the second substrate 375 may connect the first substrate 370 to the speaker 390. For example, the second substrate 375 may include a flexible printed circuit board (FPCB).

According to an embodiment, the wearable electronic device 300 may include the battery 380. For example, the battery 380 may be disposed inside the first housing (e.g., the first housing 311 in FIG. 3A). The battery 380 may supply power to the microphones 340 and 350 and the speaker 390.

According to an embodiment, the wearable electronic device 300 may include the speaker 390. For example, the speaker 390 may be disposed inside a second housing (e.g., the second housing 312 in FIG. 3A). The speaker 390 may output sound to the outside of the housing (e.g., the housing 310 in FIG. 3A).

According to an embodiment, the wearable electronic device 300 may include an ear tip 325. The ear tip 325 may be inserted into the user's ear. For example, the ear tip 325 may be fixed to the port 320.

According to an embodiment, the wearable electronic device 300 may include an output passage 321. The output passage 321 may be formed inside the port 320. The output passage 321 may face the speaker 390. Sound generated by the speaker 390 may be transmitted to the outside of the housing 310 through the output passage 321.

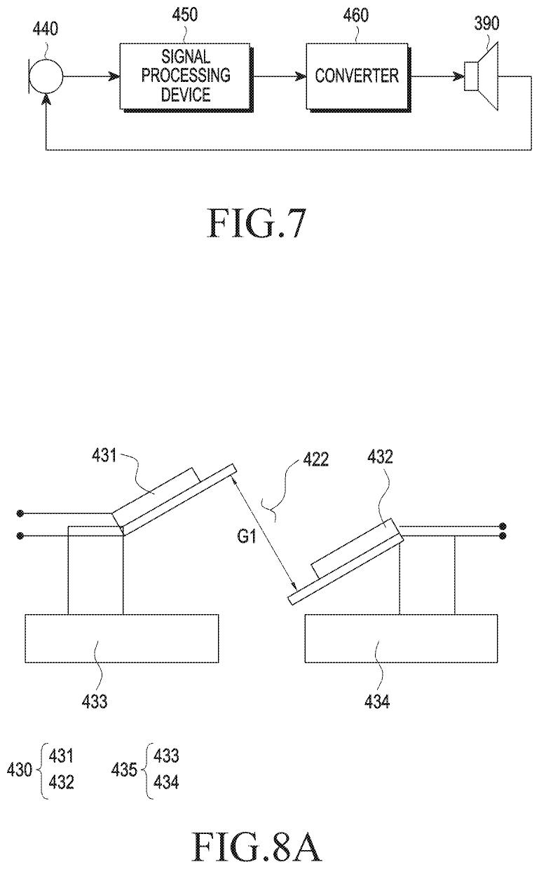

FIG. 6A is a cross-sectional view of the wearable electronic device 300 in a first state, taken along reference line B-B′ shown in FIG. 3B according to an embodiment of the disclosure. FIG. 6B is a cross-sectional view of the wearable electronic device 300 in a second state, taken along reference line B-B′ shown in FIG. 3B according to an embodiment of the disclosure. The components to be described with reference to FIGS. 6A and 6B may be partially or entirely identical to the components described with reference to FIGS. 1, 2, 3A to 3C, 4, and 5. The components to be described with reference to FIGS. 6A and 6B may be partially or entirely identical to the components to be described with reference to FIGS. 7, 8A to 8C, 9A to 9C, 10 to 15, 16A, 16B, 17, and 18.

According to an embodiment, the wearable electronic device 300 may include a housing 310, a port 320, a substrate 370, a battery 380, and a speaker 390. The substrate 370, the battery 380, and the speaker 390 may be disposed inside the housing 310. The port 320 may include an output passage 321 configured to transmit sound generated by the speaker 390 to the outside of the housing 310.

According to an embodiment, the wearable electronic device 300 may include a microphone 410. The microphone 410 may be disposed inside the output passage 321. The microphone 410 may be disposed inside the port 320. The microphone 410 may receive sound from outside the housing 310. The microphone 410 may be referred to as a “third microphone.” The wearable electronic device 300 may include a microphone (e.g., the microphone 440 in FIG. 7) including multiple microphones (e.g., the first and second microphones 340 and 350 in FIG. 5 and the microphone 410 in FIG. 6A).

According to an embodiment, the wearable electronic device 300 may include an acoustic passage 420. The acoustic passage 420 may be formed inside the housing 310. The acoustic passage 420 may be a portion of a space formed inside the housing 310. The acoustic passage 420 may connect the opening 314 to the output passage 321. The acoustic passage 420 may extend from the opening 314 toward the output passage 321. The acoustic passage 420 may communicate with the outside of the housing 310 through the opening 314. The acoustic passage 420 may be in communication with the outside of the housing 310 through the output passage 321. The acoustic passage 420 may be referred to as a “passage.” The acoustic passage 420 may be referred to as a “bypass passage.” The acoustic passage 420 may be referred to as a “vent hole.” The acoustic path 420 may be referred to as a “sound path.” The acoustic passage 420 may be referred to as a “tunnel.” The acoustic passage 420 may be referred to as a “flow passage.”

According to an embodiment, the acoustic passage 420 may include a passage 421. The passage 421 may be formed inside the housing 310. Sound outside the housing 310 may pass through the inside of the passage 421. The passage 421 may be referred to as a “conduit.” The passage 421 may be referred to as a “first conduit.” The passage 421 may be referred to as a “stream.” The passage 421 may be referred to as a “first channel.”

According to an embodiment, the acoustic passage 420 may include a first passage 423. The first passage 423 may communicate with the opening 314. The first passage 423 may connect the opening 314 to the passage 421. Sound outside the housing 310 may be transmitted to the first passage 423 through the opening 314. The sound transmitted to the first passage 423 may be transmitted to the passage 421. The housing 310 may include a recess 317 that forms the opening 314. The recess 317 may be recessed from the outer surface of the housing 310 to the inside of the housing 310. The wearable electronic device 300 may include a battery outer wall 381. The battery outer wall 381 may be disposed inside the housing 310. The battery outer wall 381 may be spaced apart from a portion of the inner surface of the housing 310. The first passage 423 may be formed between the outer wall of the battery 381 and a portion of the inner surface of the housing 310. The first passage 423 may be referred to as an “inlet.” The first passage 423 may be referred to as an “upstream portion.” The first passage 423 may be referred to as an “inlet passage.”

According to an embodiment, the acoustic passage 420 may include a second passage 424. The second passage 424 may communicate with the output passage 321. The second passage 424 may connect the output passage 321 to the passage 421. Sound outside the housing 310 may be transmitted to the second passage 424 through the passage 421. The sound transmitted to the second passage 424 may be transmitted to the output passage 321. The wearable electronic device 300 may include a speaker outer wall 391. The speaker outer wall 391 may be disposed inside the housing 310. The speaker outer wall 391 may be spaced apart from another portion of the inner surface of the housing 310. The second passage 424 may be formed between the speaker outer wall 391 and the other portion of the inner surface of the housing 310. The second passage 424 may be referred to as an “outlet.” The second passage 424 may be referred to as a “downstream portion.” The second passage 424 may be referred to as an “outlet passage.”

According to an embodiment, the acoustic passage 420 may include a channel 422. The channel 422 may be formed inside the housing 310. The channel 422 may be connected to the passage 421. The channel 422 may connect the passage 421 to the second passage 424. According to an embodiment, the channel 422 may be formed to be openable and closable. The channel 422 may be referred to as a “second channel.” The channel 422 may be referred to as a “connecting passage.” The channel 422 may be referred to as a “closable conduit.” The channel 422 may be referred to as a “flow passage.”

According to an embodiment, the wearable electronic device 300 may include an opening device 430. The opening device 430 may open the acoustic passage 420. The opening device 430 may close the acoustic passage 420. The opening device 430 may adjust the opening degree of the acoustic passage 420. The opening device 430 may open the channel 422. The opening device 430 may close the channel 422. The opening device 430 may adjust the opening degree of the channel 422. The opening device 430 may be referred to as a “closing device.” The opening device 430 may be referred to as an “opening member.” The opening device 430 may be referred to as a “closing member.” The opening device 430 may be referred to as a “door.” The opening device 430 may be referred to as a “closer.” The opening device 430 may be referred to as an “opening and closing device.”

According to an embodiment, the opening device 430 may include a first opening member 431 and/or a second opening member 432. For example, the first opening member 431 and the second opening member 432 may be disposed to face each other. For example, at least one of the first opening member 431 and the second opening member 432 may be disposed to be movable toward the other. For example, the first opening member 431 and the second opening member 432 may be disposed to be movable toward each other. The first opening member 431 may be referred to as a “first closing member.” The first opening member 431 may be referred to as a “first door.” The first opening member 431 may be referred to as a “first closer.” The second opening member 432 may be referred to as a “second closing member.” The second opening member 432 may be referred to as a “second door.” The second opening member 432 may be referred to as a “second closer.”

Referring to FIG. 6A, the first opening member 431 and the second opening member 432 may be spaced apart from each other. For example, the channel 422 may be formed between the first opening member 431 and the second opening member 432. The channel 422 may be opened. Sound outside the housing 310 may be transmitted to the output passage 321 through the passage 421 and the channel 422. For example, the state in which the channel 422 is opened may be defined as a “first state.”

Referring to FIG. 6B, the first opening member 431 and the second opening member 432 may be in contact with each other. The channel 422 may not be formed. The channel 422 may be closed. Sound outside the housing 310 may not be transmitted to the output passage 321. For example, the state in which the channel 422 is closed may be defined as a “second state.”

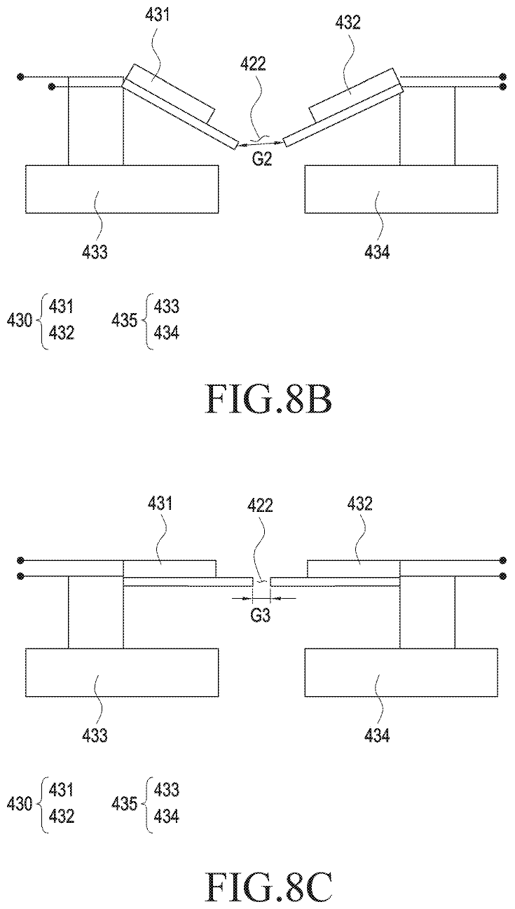

FIG. 7 is a block diagram conceptually illustrating a sound transmission path according to an embodiment of the disclosure. The components to be described with reference to FIG. 7 may be partially or entirely identical to the components described with reference to FIGS. 1, 2, 3A to 3C, 4, 5, 6A, and 6B. The components to be described with reference to FIG. 7 may be partially or entirely identical to the components to be described with reference to FIGS. 8A to 8C, 9A to 9C, 10 to 15, 16A, 16B, 17, and 18.

According to an embodiment, the wearable electronic device 300 may include a microphone 440. The microphone 440 may include multiple microphones (e.g., the first and second microphones 340 and 350 in FIG. 5 and the third microphone 410 in FIG. 6A). The multiple microphones 340, 350, and 410 may be disposed inside a housing (e.g., the housing 310 in FIG. 6A). Sound outside the housing 310 may be received by the microphone 440.

According to an embodiment, the wearable electronic device 300 may include a signal processing device 450. The signal processing device 450 may identify a signal (e.g., a vibration) corresponding to the sound received by the microphone 440. The signal processing device 450 may identify, in the form of an analog or digital signal, the signal corresponding to the sound received by the microphone 440.

According to an embodiment, the wearable electronic device 300 may include a converter 460. The converter 460 may convert the signal for the sound processed by the signal processing device 450. For example, the converter 460 may convert a digital signal for the sound processed by the signal processing device 450 into an analog signal. For example, the converter 460 may include a DAC.

According to an embodiment, the wearable electronic device 300 may include a speaker 390. The speaker 390 may output the signal converted by the converter 460 to the outside of the housing 310. Sound output from the speaker 390 may be transmitted to the outside of the housing 310. For example, the sound output from the speaker 390 and transmitted to the outside of the housing 310 may be received by the microphone 440.

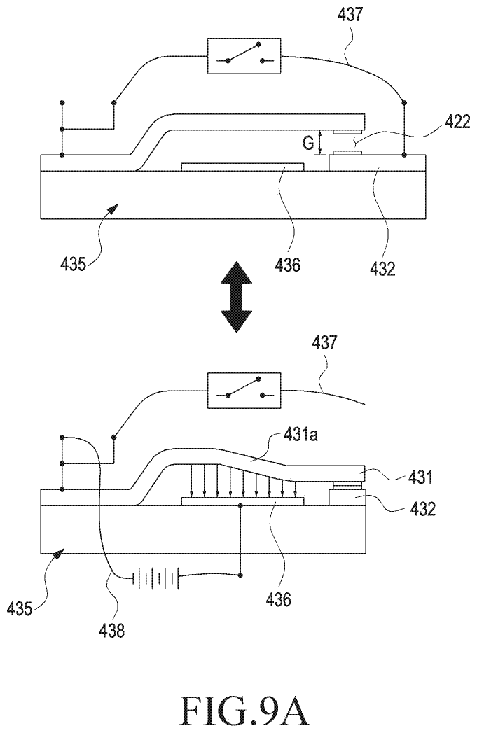

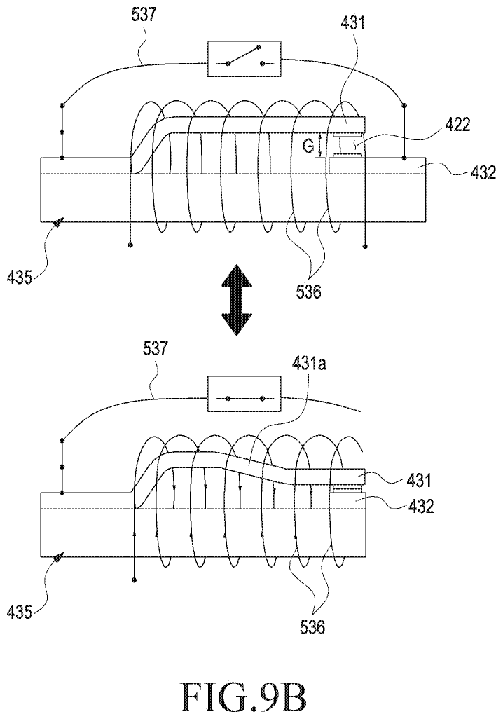

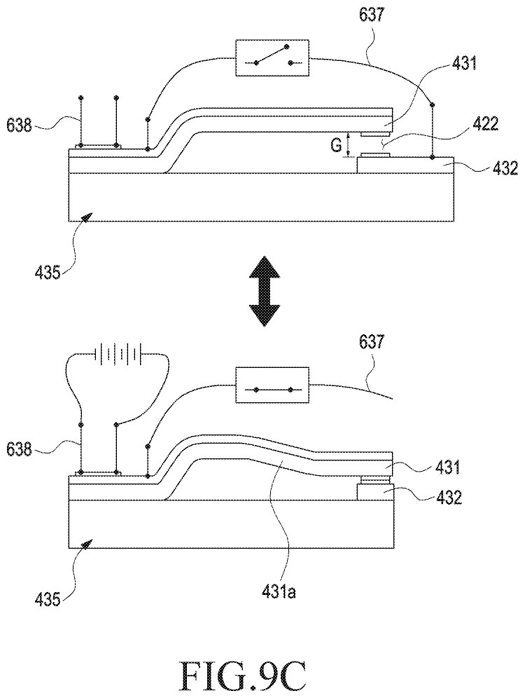

FIG. 8A is a diagram conceptually illustrating the opening device 430 in the first state of the wearable electronic device 300 according to an embodiment of the disclosure. FIG. 8B is a diagram conceptually illustrating the opening device 430 in a third state of the wearable electronic device 300 according to an embodiment of the disclosure. FIG. 8C is a diagram conceptually illustrating the opening device 430 in a second state of the wearable electronic device 300 according to an embodiment of the disclosure. The components to be described with reference to FIGS. 8A to 8C may be partially or entirely identical to the components described with reference to FIGS. 1, 2, 3A to 3C, 4, 5, 6A, 6B, and 7. The components to be described with reference to FIGS. 8A to 8C may be partially or entirely identical to the components to be described with reference to FIGS. 9A to 9C, 10 to 15, 16A, 16B, 17, and 18.

According to an embodiment, the opening device 430 may include a first opening member 431 and a second opening member 432. The description of the first and second opening members 431 and 432 with reference to FIGS. 6A and 6B may be substantially equally applied to the first and second opening members 431 and 432. A channel 422 may be formed between the first opening member 431 and the second opening member 432.

According to an embodiment, the channel 422 may be defined as “a space bounded by the components included in the wearable electronic device 300, or a set of boundary surfaces of the components.” For example, the channel 422 may include a space formed between the inner surface of the housing 310 and the battery outer wall 381. For example, the channel 422 may include a space formed between the inner surface of the housing 310 and the speaker outer wall 391. For example, the channel 422 may include a space formed between the first opening member 431 and the second opening member 432.

According to an embodiment, the channel 422 may be defined as “a portion of a space formed inside the housing 310.” The opening device 430 may be disposed to be movable toward the channel 422. The first opening member 431 may move toward the channel 422 and may close a portion of the channel 422. The first opening member 431 may be located inside the channel 422. The second opening member 432 may move toward the channel 422 and may close a portion of the channel 422. The second opening member 432 may be disposed inside the channel 422.

According to an embodiment, the wearable electronic device 300 may include a support member 435. For example, the support member 435 may be disposed inside a housing (e.g., the housing 310 in FIG. 6A). For example, the support member 435 may be fixed inside the housing 310. For example, the support member 435 may be a portion of the housing or a portion of a component disposed inside the housing. The opening device 430 may be movably disposed on the support member 435. The support member 435 may support the opening device 430. The support member 435 may include a first support member 433 on which the first opening member 431 is movably disposed. The support member 435 may include a second support member 434 on which the second opening member 432 is movably disposed.

Referring to FIG. 8A, the wearable electronic device 300 may be in a first state. For example, the first state may be defined as a fully open state of the channel 422. In the first state, the first opening member 431 and the second opening member 432 may be spaced apart from each other. In the first state, the channel 422 may be formed between the first opening member 431 and the second opening member 432.

Referring to FIG. 8B, the wearable electronic device 300 may be in a third state. For example, the third state may be defined as a semi-open state of the channel 422. The distance between the first opening member 431 and the second opening member 432 in the third state may be smaller than that in the first state. In the third state, a channel 422 may be formed between the first opening member 431 and the second opening member 432.

According to an embodiment, the wearable electronic device 300 may be in a second state. For example, the second state may be defined as a fully closed state of the channel 422. For example, in the second state, the first opening member 431 and the second opening member 432 may come into contact with each other. In the second state, the channel 422 may not be formed. In an embodiment, as illustrated in FIG. 8C, in the second state of the wearable electronic device 300, the distance between the first opening member 431 and the second opening member 432 may be smaller than that in the third state, and the channel 422 may be formed between the first opening member 431 and the second opening member 432.

Referring to FIGS. 8A to 8C, the first opening member 431 and the second opening member 432 may be spaced apart from each other. The channel 422 may be formed between the first opening member 431 and the second opening member 432. A first gap G1 between the first opening member 431 and the second opening member 432 in the first state may be greater than a second gap G3 between the first opening member 431 and the second opening member 432 in the second state. The first gap G1 between the first opening member 431 and the second opening member 432 in the first state may be greater than a third gap G2 between the first opening member 431 and the second opening member 432 in the third state. The second gap G3 between the first opening member 431 and the second opening member 432 in the second state may be smaller than the third gap G2 between the first opening member 431 and the second opening member 432 in the third state.

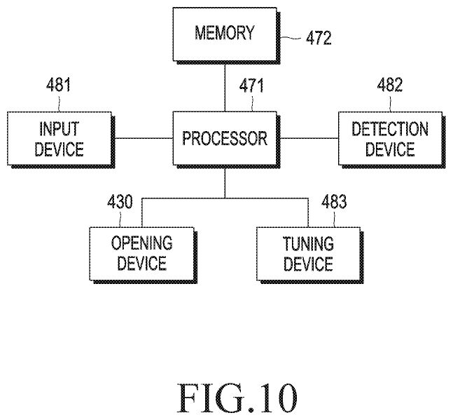

FIG. 9A is a diagram illustrating a method for operating the opening device 430 according to an embodiment of the disclosure. FIG. 9B is a diagram illustrating a method for operating the opening device 430 according to an embodiment of the disclosure. FIG. 9C is a diagram illustrating a method for operating the opening device 430 according to an embodiment of the disclosure. The components to be described with reference to FIGS. 9A to 9C may be partially or entirely identical to the components described with reference to FIGS. 1, 2, 3A to 3C, 4, 5, 6A, 6B, 7, and 8A to 8C. The components to be described with reference to FIGS. 9A to 9C may be partially or entirely identical to the components to be described with reference to FIGS. 10 to 15, 16A, 16B, 17, and 18.

According to an embodiment, the opening device 430 may be opened and closed by an electrostatic actuation method. The opening device 430 may be opened and closed by an electromagnetic actuation method. The opening device 430 may be opened and closed by a piezoelectric actuation method.

Referring to FIG. 9A, the opening device 430 may include a conductive member 436, a first circuit 437, and a second circuit 438. In a first state, a first opening member 431 and a second opening member 432 may be spaced apart from each other to form a gap G therebetween. A channel 422 may be formed between the first opening member 431 and the second opening member 432. In the first state, a first circuit 437 may be electrically connected to the second opening member 432. In the first state, a repulsive force may be formed between the first opening member 431 and the second opening member 432. In a second state, the first opening member 431 and the second opening member 432 may be in close contact with each other to close the channel 422. In the second state, at least a portion of the first opening member 431 may be bent. The first opening member 431 may include a bending portion 431a. In the second state, the second circuit 438 may be electrically connected to a conductive member 436. In the second state, an attractive force may be formed between the first opening member 431 and the second opening member 432. In an embodiment, the first opening member 431 may include a material having elasticity. In the first state, the gap G may be formed between the first opening member 431 and the second opening member 432, and in the second state, the attractive force may be formed between the first opening member 431 and the second opening member 432. When transitioning from the first state to the second state, a current may be applied to at least one of the first opening member 431 and the second opening member 432, and an attractive force may be generated between the first opening member 431 and the second opening member 432. When transitioning from the second state to the first state, a current may not be applied to the first opening member 431 and the second opening member 432, and the first opening member 431 and the second opening member 432 may be spaced apart by the restoring force of the first opening member 431.

Referring to FIG. 9B, the opening device 430 may include a coil 536 and a first circuit 537. In a first state, the first opening member 431 and the second opening member 432 may be spaced apart from each other to form a gap G therebetween. A channel 422 may be formed between the first opening member 431 and the second opening member 432. In the first state, the circuit 537 may block an electrical connection between the first opening member 431 and the second opening member 432. For example, in the first state, a repulsive force may be formed between the first opening member 431 and the second opening member 432. In a second state, the first opening member 431 and the second opening member 432 may be in close contact with each other to close the channel 422. In the second state, at least a portion of the first opening member 431 may be bent. The first opening member 431 may include a bending portion 431a. In the second state, the first circuit 537 may electrically connect the first opening member 431 to the second opening member 432. In the second state, a current may be applied to the coil 536. In the second state, an attractive force may be formed between the first opening member 431 and the second opening member 432. In the second state, an electromagnetic force may be formed between the first opening member 431 and the second opening member 432 due to the current applied through the first circuit 537 and the current applied through the coil 536. A support member 435 may include a conductive material.

Referring to FIG. 9C, the opening device 430 may include a first circuit 637 and a second circuit 638. In a first state, the first opening member 431 and the second opening member 432 may be spaced apart from each other to form a gap G therebetween. A channel 422 may be formed between the first opening member 431 and the second opening member 432. In the first state, the first circuit 637 may block an electrical connection between the first opening member 431 and the second opening member 432. For example, in the first state, a repulsive force may be generated between the first opening member 431 and the second opening member 432. In a second state, the first opening member 431 and the second opening member 432 may be in close contact with each other to close the channel 422. In the second state, at least a portion of the first opening member 431 may be bent. The first opening member 431 may include a bending portion 431a. In the second state, the first circuit 637 may electrically connect the first opening member 431 to the second opening member 432. In the second state, the second circuit 638 may apply a voltage to the first opening member 431. The first opening member 431 may include a piezoelectric element. The first opening member 431 may include a material that contracts when voltage is applied thereto. The first opening member 431 may include a conductive material.

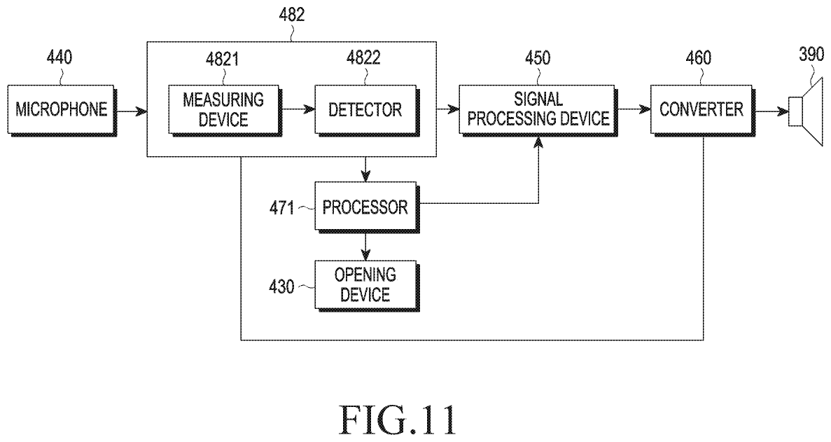

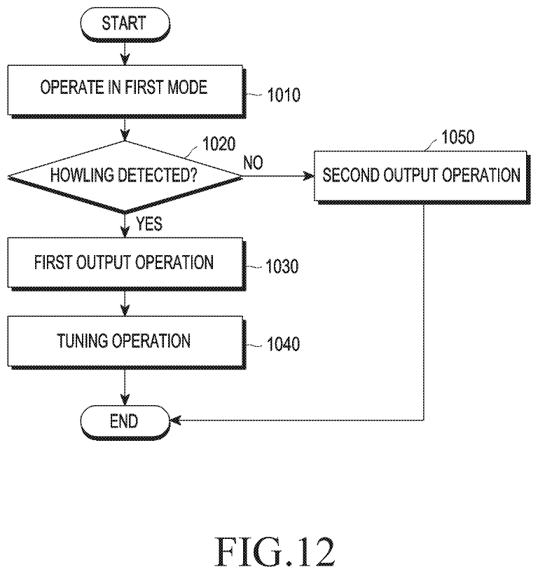

FIG. 10 is a block diagram conceptually illustrating the relationship between components 430, 471, 472, 481, 482, and 483 of the wearable electronic device 300 according to an embodiment of the disclosure. FIG. 11 is a block diagram conceptually illustrating a method for operating the wearable electronic device 300 according to an embodiment of the disclosure. The components to be described with reference to FIGS. 10 and 11 may be partially or entirely identical to the components described with reference to FIGS. 1, 2, 3A to 3C, 4, 5, 6A, 6B, 7, 8A to 8C, and 9A to 9C. The components to be described with reference to FIGS. 10 and 11 may be partially or entirely identical to the components to be described with reference to FIGS. 12 to 15, 16A, 16B, 17, and 18.

According to an embodiment, the wearable electronic device 300 may include a processor 471. The processor 471 may be substantially identical to the processor 120 described with reference to FIG. 1. The description of the processor 120 with reference to FIG. 1 may be equally applied to the processor 471. The wearable electronic device 300 may include memory 472. The memory 472 may be substantially identical to the memory 130 described with reference to FIG. 1. The description of the memory 130 with reference to FIG. 1 may be equally applied to the memory 472.

According to an embodiment, the wearable electronic device 300 may include an opening device 430. The description of the opening device 430 with reference to FIGS. 6A, 6B, 7, 8A to 8C, and 9A to 9C may be substantially equally applied to the opening device 430.

According to an embodiment, the wearable electronic device 300 may include a signal processing device 450 and a converter 460. The description of the signal processing device 450 and the converter 460 with reference to FIG. 7 may be substantially equally applied to the signal processing device 450 and the converter 460.

According to an embodiment, the wearable electronic device 300 may include an input device 481. The input device 481 may be exposed to the outside of a housing (e.g., the housing 310 in FIG. 6A). The input device 481 may be arranged to be touchable. A user may input a signal to the input device 481. For example, the wearable electronic device 300 may change the operating mode of the wearable electronic device 300, based on a signal input by the user to the input device 481.

According to an embodiment, the wearable electronic device 300 may include a detection device 482. The detection device 482 may detect a signal for sound received through a microphone 440. The detection device 482 may detect noise in the sound received through the microphone 440. The detection device 482 may detect howling of sound received through the microphone 440. The detection device 482 may include a measuring device 4821 that senses a signal (e.g., a sound wave) received through the microphone 440. For example, the detection device 482 may include a detector 4822 that detects howling from a signal sensed by the measuring device 4821.

According to an embodiment, the wearable electronic device 300 may include a tuning device 483. The tuning device 483 may adjust a signal for sound output through the speaker 390.

According to an embodiment, the processor 471 may receive a signal from the input device 481. For example, the processor 471 may receive information about an operating mode of the wearable electronic device 300 from the input device 481. The processor 471 may receive a signal from the detection device 482. For example, the processor 471 may receive, from the detection device 482, information about howling of sound received through the microphone 440. The processor 471 may transmit a signal to the tuning device 483. The processor 471 may transmit a signal to the opening device 430. For example, the processor 471 may adjust the opening device 430 so that the wearable electronic device 300 operates in a first state, a second state, or a third state. For example, the processor 471 may adjust the opening degree of a channel (e.g., the channel 422 in FIGS. 8A and 8B) such that the wearable electronic device 300 operates in the first state, the second state, or the third state.

According to an embodiment, noise (e.g., howling) included in the sound received through the microphone 440 may be detected by the detection device 482. When the noise is detected by the detection device 482, the processor 471 may adjust the opening device 430.

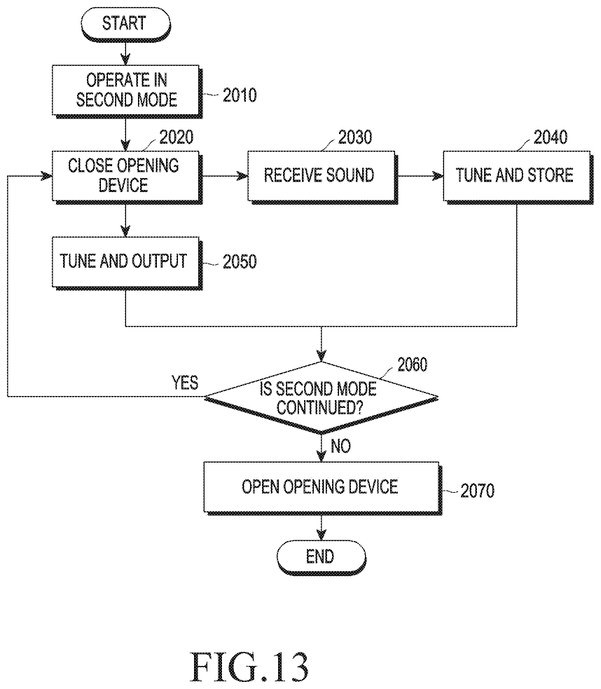

FIG. 12 is a control block diagram of the wearable electronic device 300 operating in a first mode according to an embodiment of the disclosure. The components to be described with reference to FIG. 12 may be partially or entirely identical to the components described with reference to FIGS. 1, 2, 3A to 3C, 4, 5, 6A, 6B, 7, 8A to 8C, 9A to 9C, 10, and 11. Referring to FIG. 12, the components to be described may be partially or entirely identical to the components to be described with reference to FIGS. 13 to 15, 16A, 16B, 17, and 18.

Referring to FIGS. 10, 11, and 12, the wearable electronic device 300 may include a processor 471 and memory 472. The processor 471 may include at least one processor, and the description of the processor 120 with reference to FIG. 1 may be equally applied to the processor 471. The description of the memory 130 with reference to FIG. 1 may be equally applied to the memory 472. The memory 472 may store instructions. The memory 472 may be executed by the processor 471. The memory 472, when executed by the processor 471, may cause the processor 471 to perform predetermined operations.

Referring to FIGS. 10, 11, and 12, a method for operating the wearable electronic device 300 may include an operation 1010 in which the wearable electronic device 300 operates in a first mode. The first mode may be defined as a mode in which the wearable electronic device 300 operates in a state which the opening device 430 has opened a channel (e.g., the channel 422 in FIGS. 8A and 8B). The processor 471 may operate the wearable electronic device 300 in the first mode, based on a signal input to the input device 481. The user may input a signal to the input device 481 to cause the wearable electronic device 300 to operate in the first mode. The first mode may be referred to as an “ambient sound listening mode.”

Referring to FIGS. 10, 11, and 12, the method for operating the wearable electronic device 300 may include an operation 1020 in which the wearable electronic device 300 detects howling of sound received from the microphone 440. The detection device 482 may detect noise (e.g., howling) included in the sound received through the microphone 440. The detection device 482 may detect a wave of the sound received through the microphone 440. For example, the measuring device 4821 may detect the wave of the sound received through the microphone 440. The detection device 482 may detect information about noise (e.g., howling) from the wave of the sound received through the microphone 440. For example, the detector 4822 may detect information about a frequency band in which the wave is amplified, in a wave graph of sound received through the microphone 440.

Referring to FIGS. 10, 11, and 12, the method for operating the wearable electronic device 300 may include a first output operation 1030 of the wearable electronic device 300. The first output operation 1030 may be an operation in which the processor 471 adjusts the opening degree of the opening device 430. For example, when the processor 471 receives the information about the noise (e.g., howling) from the detection device 482, the processor 471 may control the opening device 430 to reduce the opening degree of the opening device 430.

Referring to FIGS. 10, 11, and 12, the method for operating the wearable electronic device 300 may include a second output operation 1050 of the wearable electronic device 300. The second output operation 1050 may be an operation in which the processor 471 maintains the opening degree of the opening device 430. For example, when the processor 471 does not receive the information about the noise (e.g., howling) from the detection device 482, the processor 471 may maintain the opening degree of the opening device 430 in a fully opened state. When the processor 471 does not receive the information about the noise (e.g., howling) from the detection device 482, the processor 471 may control the opening device 430 such that the opening device 430 operates in the first state shown in FIG. 8A.

Referring to FIGS. 10, 11, and 12, the method for operating the wearable electronic device 300 may include an operation 1040 of tuning sound output through the speaker 390. When receiving the information about the noise (e.g., howling) from the detection device 482, the processor 471 may control the tuning device 483, based on the information. For example, the processor 471 may receive, from the detection device 482, information about a frequency band in which the noise is generated, and may control the tuning device 483 to reduce the output (e.g., amplitude of the wave) of the frequency band. According to an embodiment of the disclosure, the processor 471 may tune sound based on the degree to which the opening device 430 opens and closes the channel 422. Operation 1040 of tuning the sound may also be performed by the signal processing device 450 in the manner described above.

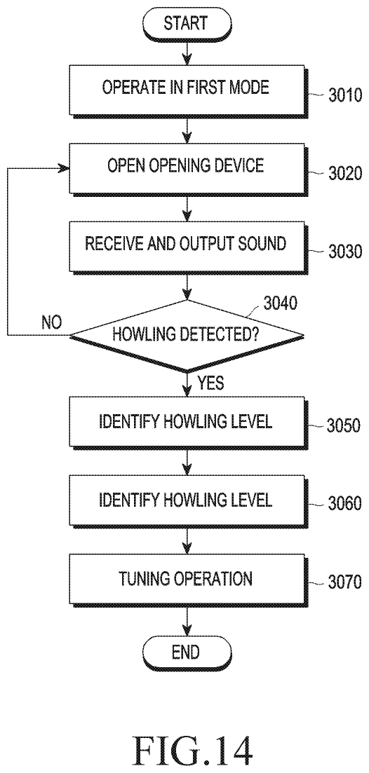

FIG. 13 is a control block diagram of the wearable electronic device 300 operating in a second mode according to an embodiment of the disclosure. The components to be described with reference to FIG. 13 may be partially or entirely identical to the components described with reference to FIGS. 1, 2, 3A to 3C, 4, 5, 6A, 6B, 7, 8A to 8C, 9A to 9C, and 10 to 12. The components to be described with reference to FIG. 13 may be partially or entirely identical to the components to be described with reference to FIGS. 14, 15, 16A, 16B, 17, and 18.

Referring to FIGS. 10, 11, and 13, the wearable electronic device 300 may include a processor 471 and memory 472. The processor 471 may include at least one processor, and the description of the processor 120 with reference to FIG. 1 may be equally applied to the processor 471. The description of the memory 130 with reference to FIG. 1 may be equally applied to the memory 472. The memory 472 may store instructions. The memory 472 may be executed by the processor 471. The memory 472, when executed by the processor 471, may cause the processor 471 to perform predetermined operations.

Referring to FIGS. 10, 11, and 13, a method for operating the wearable electronic device 300 may include an operation 2010 in which the wearable electronic device 300 operates in a second mode. The second mode may be defined as a mode in which the wearable electronic device 300 operates in a state in which the opening device 430 has closed a channel (e.g., the channel 422 in FIGS. 8A and 8B). The processor 471 may operate the wearable electronic device 300 in the second mode, based on a signal input to the input device 481. The user may input a signal to the input device 481 to cause the wearable electronic device 300 to operate in the second mode. The second mode may include an operation of recording sound received through the microphone 440 by using the microphone 440. For example, the second mode may be referred to as a “recording mode.”

Referring to FIGS. 10, 11, and 13, the method for operating the wearable electronic device 300 may include an operation 2020 of closing the opening device 430. When the processor 471 receives, through the input device 481, a signal indicating that the wearable electronic device 300 operates in the second mode, the processor 471 may control the opening device 430 such that the opening device 430 is closed.

Referring to FIGS. 10, 11, and 13, the method for operating the wearable electronic device 300 may include an operation 2030 of receiving sound. When the wearable electronic device 300 operates in the second mode, the wearable electronic device 300 may receive sound through the microphone 440.

Referring to FIGS. 10, 11, and 13, the method for operating the wearable electronic device 300 may include an operation 2040 of tuning and storing the received sound. When the wearable electronic device 300 operates in the second mode, the sound received through the microphone 440 may be processed by the tuning device 483 and then stored.

Referring to FIGS. 10, 11, and 13, the method for operating the wearable electronic device 300 may include an operation 2050 of tuning and outputting sound. When the wearable electronic device 300 operates in the second mode, sound recorded by the microphone 440 may be processed by the tuning device 483 and then output through the speaker 390.

Referring to FIGS. 10, 11, and 13, the method for operating the wearable electronic device 300 may include an operation 2060 of determining whether the second mode is continued. While the wearable electronic device 300 is operating in the second mode, the processor 471 may receive a signal for the mode of the wearable electronic device 300 from the input device 481. The signal may be a signal for switching the mode of the wearable electronic device 300 from a second mode to a first mode. For example, when receiving a signal for the second mode from the input device 481, the processor 471 may maintain the closed state of the opening device 430. For example, when the processor 471 does not receive a signal for the second mode from the input device 481, the processor 471 may control the opening device 430 such that the opening device 430 is opened. For example, when the processor 471 receives a signal for the first mode from the input device 481, the processor 471 may control the opening device 430 such that the opening device 430 is opened.

Referring to FIGS. 10, 11, and 13, the method for operating the wearable electronic device 300 may include an operation 2070 of opening the opening device 430. While the wearable electronic device 300 is operating in the second mode, the processor 471 may receive, from the input device 481, a signal for stopping the operation in the second mode. When the signal for stopping the operation in the second mode is received from the input device 481, the processor 471 may open the opening device 430. when the signal for stopping the operation in the second mode is received from the input device 481, the processor 471 may open the opening device 430 as shown in FIG. 8A or 8B.

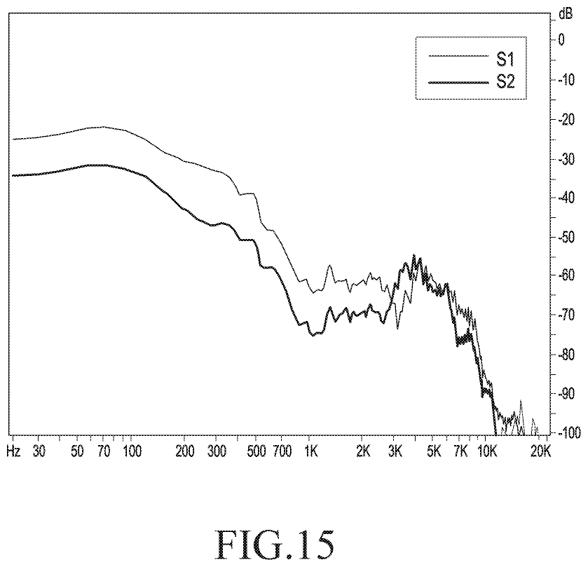

FIG. 14 is a control block diagram of the wearable electronic device 300 operating in a first mode according to an embodiment of the disclosure. The components to be described with reference to FIG. 14 may be partially or entirely identical to the components described with reference to FIGS. 1, 2, 3A to 3C, 4, 5, 6A, 6B, 7, 8A to 8C, 9A to 9C, and 10 to 13. The components to be described with reference to FIG. 14 may be partially or entirely identical to the components to be described with reference to FIGS. 15, 16A, 16B, 17, and 18.

Referring to FIGS. 10, 11, and 14, the wearable electronic device 300 may include a processor 471 and memory 472. The processor 471 may include at least one processor, and the description of the processor 120 with reference to FIG. 1 may be equally applied to the processor 471. The description of the memory 130 with reference to FIG. 1 may be equally applied to the memory 472. The memory 472 may store instructions. The memory 472 may be executed by the processor 471. The memory 472, when executed by the processor 471, may cause the processor 471 to perform predetermined operations.

Referring to FIGS. 10, 11, and 14, a method for operating the wearable electronic device 300 may include an operation 3010 in which the wearable electronic device 300 operates in a first mode. The first mode may be defined as a mode in which the wearable electronic device 300 operates in a state in which the opening device 430 opened a channel (e.g., the channel 422 in FIGS. 8A and 8B). The processor 471 may operate the wearable electronic device 300 in the first mode, based on a signal input to the input device 481. The user may input a signal to the input device 481 to cause the wearable electronic device 300 to operate in the first mode. For example, the first mode may be referred to as “ambient sound listening mode.”

Referring to FIGS. 10, 11, and 14, the method for operating the wearable electronic device 300 may include an operation 3020 of opening the opening device 430. The processor 471 may open the opening device 430 while the wearable electronic device 300 is operating in the first mode.

Referring to FIGS. 10, 11, and 14, the method for operating the wearable electronic device 300 may include an operation 3030 of receiving sound through the microphone 440 and outputting the received sound through the speaker 390.

Referring to FIGS. 10, 11, and 14, the method for operating the wearable electronic device 300 may include an operation 3040 in which the wearable electronic device 300 detects howling of the sound received from the microphone 440. The detection device 482 may detect noise (e.g., howling) included in the sound received from the microphone 440. The detection device 482 may detect a wave of the sound received through the microphone 440. For example, the measuring device 4821 may detect a wave of the sound received through the microphone 440. The detection device 482 may detect information about noise (e.g., howling) from the wave of the sound received through the microphone 440. For example, the detector 4822 may detect information about a frequency band in which the wave has been amplified, in a wave graph of the sound received through the microphone 440.

Referring to FIGS. 10, 11, and 14, the method for operating the wearable electronic device 300 may include an operation 3050 of identifying the level of howling. The processor 471 may receive the information about the noise detected by the detection device 482. The processor 471 may identify the level of noise detected by the detection device 482 (e.g., the amplitude of a frequency band in which howling has occurred).

Referring to FIGS. 10, 11, and 14, the method for operating the wearable electronic device 300 may include an operation 3060 of adjusting the opening degree of the opening device 430. The processor 471 may compare the level of noise detected by the detection device 482 with stored information (instructions). For example, the stored information may be stored in the memory 472. The memory 472 may store information about the opening degree of the opening device 430 corresponding to the level of noise. The memory 472 may store information about the opening degree of the opening device 430 corresponding to the frequency band of the noise. The processor 471 may adjust the opening degree of the opening device 430, based on the above information. For example, the processor 471 may control the opening device 430 to an opening degree corresponding to the level of noise detected by the detection device 482. For example, the processor 471 may control the opening device 430 to an opening degree corresponding to the frequency band of the noise detected by the detection device 482.

Referring to FIGS. 10, 11, and 14, the method for operating the wearable electronic device 300 may include a tuning operation 3070. After the opening degree of the opening device 430 is adjusted by the processor 471, sound received through the microphone 440 may be processed by the tuning device 483 and the signal processing device 450. For example, the tuning device 483 and the signal processing device 450 may process sound through an EQ tuning method.

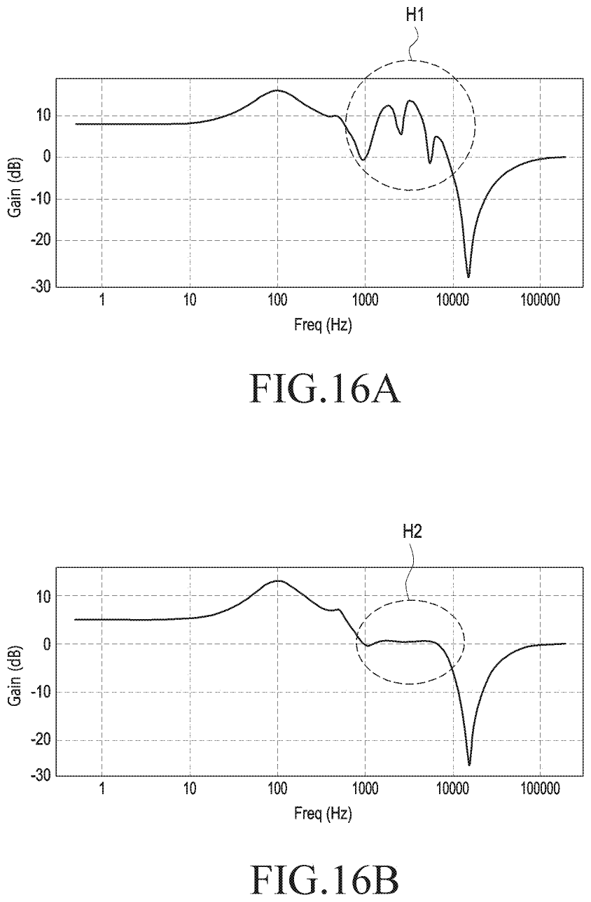

FIGS. 15, 16A, and 16B are diagrams illustrating the effects of the wearable electronic device 300 according to various embodiments of the disclosure. The components to be described with reference to FIGS. 15, 16A, and 16B may be partially or entirely identical to the components described with reference to FIGS. 1, 2, 3A to 3C, 4, 5, 6A, 6B, 7, 8A to 8C, 9A to 9C, and 10 to 14.

Referring to FIG. 15, information about sound transmitted through the speaker 390 when the acoustic passage 420 is opened or closed by the opening device 430 may be observed. Graph S1 is a graph representing sound information (e.g., dB) according to frequency bands when the acoustic passage 420 is opened. Graph S2 is a graph representing sound information (e.g., dB) according to frequency bands when the acoustic passage 420 is closed. It can be observed that when the acoustic passage 420 is opened, the level (dB) of sound in the first frequency band (e.g., less than 3K) is higher than when the acoustic passage 420 is closed. It can be observed that when the acoustic passage 420 is opened, the level (dB) of sound in a second frequency band (e.g., 3K to 5K) is lower than when the acoustic passage 420 is closed. Accordingly, the wearable electronic device 300 according to various embodiments of the disclosure may control the operation of the opening device 430 according to sound transmitted through the acoustic passage 420, thereby adjusting the level (dB) of sound output through the speaker 390.

Referring to FIGS. 16A and 16B, the wearable electronic device according to an embodiment of the disclosure may be compared with a wearable electronic device according to a comparative embodiment. FIG. 16A is a graph of information about sound according to a comparative embodiment in which control of an opening device is not performed. FIG. 16B is a graph of information about sound according to an embodiment of the disclosure in which control of the opening device 430 is performed. Referring to FIG. 16A, it can be observed that sound is amplified in a predetermined frequency band (e.g., 1000 to 10000 Hz) H1 by the sound transmitted through an acoustic passage. In the wearable electronic device according to the comparative embodiment in FIG. 16A, howling may occur due to the amplification of sound in the frequency band H1. Referring to FIG. 16B, in the wearable electronic device according to an embodiment of the disclosure, sound is not amplified in the frequency band (e.g., 1000 to 10000 Hz) H2, and thus howling does not occur.

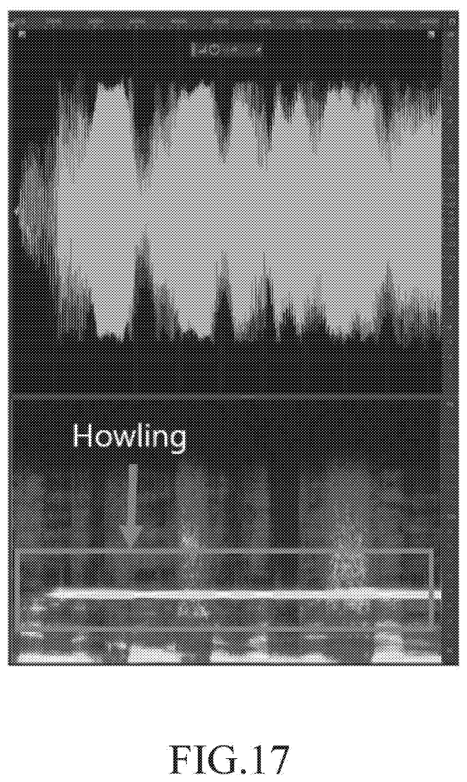

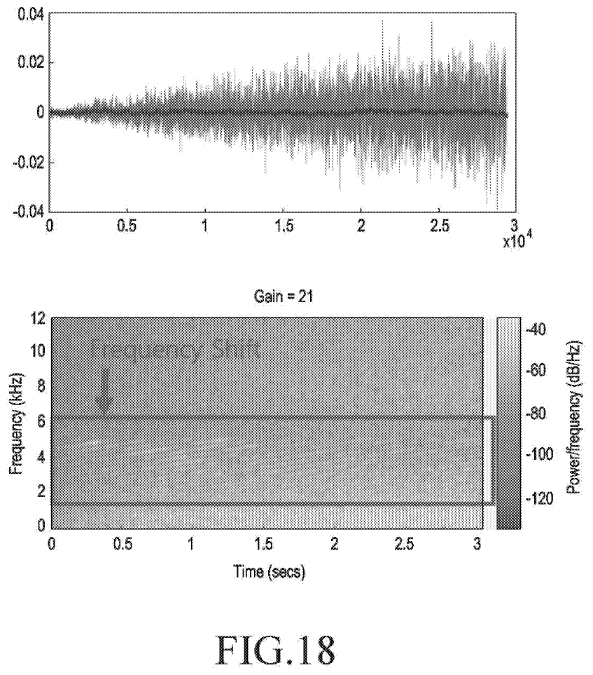

FIGS. 17 and 18 are diagrams illustrating howling occurring in a wearable electronic device according to various embodiments of the disclosure. FIG. 17 is a diagram visually illustrating howling that occurs when sound is amplified in a predetermined frequency band. FIG. 18 is a drawing illustrating that a frequency shift occurs due to the operation of the wearable electronic device for removing the howling.

A wearable electronic device may be worn in the user's ear. The wearable electronic device may include a housing in which a speaker and a microphone are disposed. The speaker may output sound to the outside of the housing, and the microphone may receive sound from the outside of the housing. The sound output to the outside of the housing through the speaker may be received again by the microphone via an acoustic passage formed inside the housing. When the acoustic passage is permanently opened, the sound output to the outside of the housing through the speaker may be continuously received by the microphone through the acoustic passage, thereby causing amplification in a predetermined frequency band.

A problem to be solved in the disclosure may be to reduce noise in sound received through a microphone.

A problem to be solved in the disclosure may be to control the transmission of sound through an acoustic passage.

Problems to be solved in the disclosure are not limited to the aforementioned problems, and may be variously defined without departing from the spirit and scope of the disclosure.

An electronic device according to various embodiments of the disclosure may reduce noise in sound by controlling the opening degree of an acoustic passage based on whether noise is included in sound received by the microphone.

The electronic device according to various embodiments of the disclosure may control an opening device for adjusting the opening degree of the acoustic passage, based on whether noise is included in sound.

The effects obtainable from the disclosure are not limited to the effects mentioned above, and other effects not mentioned will be clearly understood by those skilled in the art to which the disclosure pertains from the following description.

According to an embodiment of the disclosure, a wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include a speaker (e.g., 390 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include a microphone (e.g., 440 in FIGS. 1, 2, 3A to 3C, 4, 5, 6A, 6B, 7, 8A to 8C, 9A to 9C, 10 to 15, 16A, 16B, 17, and 18) spaced apart from the speaker (e.g., 390 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include a housing (e.g., 310 in FIGS. 1, 2, 3A to 3C, 4, 5, 6A, 6B, 7, 8A to 8C, 9A to 9C, 10 to 15, 16A, 16B, 17, and 18) configured to accommodate the speaker (e.g., 390 in FIGS. 1, 2, 3A to 3C, 4, 5, 6A, 6B, 7, 8A to 8C, 9A to 9C, 10 to 15, 16A, 16B, 17, and 18) and the microphone (e.g., 440 in FIGS. 1, 2, 3A to 3C, 4, 5, 6A, 6B, 7, 8A to 8C, 9A to 9C, 10 to 15, 16A, 16B, 17, and 18), and including an output passage (e.g., 321 in FIGS. 1, 2, 3A to 3C, 4, 5, 6A, 6B, 7, 8A to 8C, 9A to 9C, 10 to 15, 16A, 16B, 17, and 18) configured to transmit sound output from the speaker (e.g., 390 in FIGS. 1, 2, 3A to 3C, 4, 5, 6A, 6B, 7, 8A to 8C, 9A to 9C, 10 to 15, 16A, 16B, 17, and 18) and an acoustic passage (e.g., 420 in FIGS. 1, 2, 3A to 3C, 4, 5, 6A, 6B, 7, 8A to 8C, 9A to 9C, 10 to 15, 16A, 16B, 17, and 18) configured to transmit sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include an opening device (e.g., 430 in FIGS. 1, 2, 3A to 3C, 4, 5, 6A, 6B, 7, 8A to 8C, 9A to 9C, 10 to 15, 16A, 16B, 17, and 18) configured to open and close at least a portion of the acoustic passage (e.g., 420 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include a detection device (e.g., 482 in FIGS. 1, 2, 3A to 3C, 4, 5, 6A, 6B, 7, 8A to 8C, 9A to 9C, 10 to 15, 16A, 16B, 17, and 18) configured to sense information about the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include memory (e.g., 130 or 472 in FIGS. 1, 2, 3A to 3C, 4, 5, 6A, 6B, 7, 8A to 8C, 9A to 9C, 10 to 15, 16A, 16B, 17, and 18) configured to store instructions.

According to an embodiment of the disclosure, the instructions, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), may cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to operate the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18) to control the opening device (e.g., 430 in FIGS. 1, 2, 3A to 3C, 4, 5, 6A, 6B, 7, 8A to 8C, 9A to 9C, 10 to 15, 16A, 16B, 17, and 18), based on the information sensed by the detection device (e.g., 482 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the information sensed by the detection device (e.g., 482 in FIGS. 1, 2, 3A to 3C, 4, 5, 6A, 6B, 7, 8A to 8C, 9A to 9C, 10 to 15, 16A, 16B, 17, and 18) may be information about howling included in the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the detection device (e.g., 482 in FIGS. 1, 2, 3A to 3C, 4, 5, 6A, 6B, 7, 8A to 8C, 9A to 9C, 10 to 15, 16A, 16B, 17, and 18) may be configured to identify whether the howling has occurred, based on a wave of the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the detection device (e.g., 482 in FIGS. 1, 2, 3A to 3C, 4, 5, 6A, 6B, 7, 8A to 8C, 9A to 9C, 10 to 15, 16A, 16B, 17, and 18) may include a measuring device (e.g., 4821 in FIGS. 1, 2, 3A to 3C, 4, 5, 6A, 6B, 7, 8A to 8C, 9A to 9C, 10 to 15, 16A, 16B, 17, and 18) configured to sense the wave of the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the detection device (e.g., 482 in FIGS. 1, 2, 3A to 3C, 4, 5, 6A, 6B, 7, 8A to 8C, 9A to 9C, 10 to 15, 16A, 16B, 17, and 18) may include a detector (e.g., 4822 in FIGS. 1, 2, 3A to 3C, 4, 5, 6A, 6B, 7, 8A to 8C, 9A to 9C, 10 to 15, 16A, 16B, 17, and 18) configured to identify whether the howling has occurred, based on the waves sensed by the measuring device (e.g., 4821 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to control, based on the information sensed by the detection device (e.g., 482 in FIGS. 1, 2, 3A to 3C, 4, 5, 6A, 6B, 7, 8A to 8C, 9A to 9C, 10 to 15, 16A, 16B, 17, and 18), the opening device (e.g., 430 in FIGS. 1, 2, 3A to 3C, 4, 5, 6A, 6B, 7, 8A to 8C, 9A to 9C, 10 to 15, 16A, 16B, 17, and 18) such that the opening degree of the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) is adjusted.

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to control the opening device (e.g., 430 in FIGS. 1, 2, 3A to 3C, 4, 5, 6A, 6B, 7, 8A to 8C, 9A to 9C, 10 to 15, 16A, 16B, 17, and 18) to close the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) in case that the howling sound is included in the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to control the opening device (e.g., 430 in FIGS. 1, 2, 3A to 3C, 4, 5, 6A, 6B, 7, 8A to 8C, 9A to 9C, 10 to 15, 16A, 16B, 17, and 18) to open the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) in case that the howling is not included in the sound received by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to control the opening device (e.g., 430 in FIGS. 1, 2, 3A to 3C, 4, 5, 6A, 6B, 7, 8A to 8C, 9A to 9C, 10 to 15, 16A, 16B, 17, and 18) such that the opening degree of the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) varies depending on the level of the howling included in the sound receive by the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to operate in one of a first mode, in which the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) is opened, and a second mode, in which the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) is closed.

According to an embodiment of the disclosure, the instructions may be configured to, when executed by the at least one processor (e.g., 120 or 471 in FIGS. 1, 2, 3A to 3C, 4, 5, 6A, 6B, 7, 8A to 8C, 9A to 9C, 10 to 15, 16A, 16B, 17, and 18), cause the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) to control the opening device (e.g., 430 in FIGS. 1, 2, 3A to 3C, 4, 5, 6A, 6B, 7, 8A to 8C, 9A to 9C, 10 to 15, 16A, 16B, 17, and 18) to open the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) in case that the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) switches from the second mode to the first mode.

According to an embodiment of the disclosure, the housing (e.g., 310 in FIGS. 1, 2, 3A to 3C, 4, 5, 6A, 6B, 7, 8A to 8C, 9A to 9C, 10 to 15, 16A, 16B, 17, and 18) may include an opening (e.g., 314 in FIGS. 1, 2, 3A to 3C, 4, 5, 6A, 6B, 7, 8A to 8C, 9A to 9C, 10 to 15, 16A, 16B, 17, and 18) that communicates with the outside of the housing (e.g., 310 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) may extend from the opening (e.g., 314 in FIGS. 1, 2, 3A to 3C, 4, 5, 6A, 6B, 7, 8A to 8C, 9A to 9C, 10 to 15, 16A, 16B, 17, and 18) toward the output passage (e.g., 321 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) may include a passage (e.g., 421 in FIGS. 1, 2, 3A to 3C, 4, 5, 6A, 6B, 7, 8A to 8C, 9A to 9C, 10 to 15, 16A, 16B, 17, and 18) formed inside the housing (e.g., 310 in FIGS. 1, 2, 3A to 3C, 4, 5, 6A, 6B, 7, 8A to 8C, 9A to 9C, 10 to 15, 16A, 16B, 17, and 18) toward the output passage (e.g., 321 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) may include a channel (e.g., 422 in FIGS. 1, 2, 3A to 3C, 4, 5, 6A, 6B, 7, 8A to 8C, 9A to 9C, 10 to 15, 16A, 16B, 17, and 18) that is connected to the passage (e.g., 421 in FIGS. 1, 2, 3A to 3C, 4, 5, 6A, 6B, 7, 8A to 8C, 9A to 9C, 10 to 15, 16A, 16B, 17, and 18) and is formed to be closable by the opening device (e.g., 430 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) may include a first passage (e.g., 423 in FIGS. 1, 2, 3A to 3C, 4, 5, 6A, 6B, 7, 8A to 8C, 9A to 9C, 10 to 15, 16A, 16B, 17, and 18) that connects the opening (e.g., 314 in FIGS. 1, 2, 3A to 3C, 4, 5, 6A, 6B, 7, 8A to 8C, 9A to 9C, 10 to 15, 16A, 16B, 17, and 18) to the passage (e.g., 421 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) may include a second passage (e.g., 424 in FIGS. 1, 2, 3A to 3C, 4, 5, 6A, 6B, 7, 8A to 8C, 9A to 9C, 10 to 15, 16A, 16B, 17, and 18) that connects the channel (e.g., 422 in FIGS. 1, 2, 3A to 3C, 4, 5, 6A, 6B, 7, 8A to 8C, 9A to 9C, 10 to 15, 16A, 16B, 17, and 18) to the output passage (e.g., 321 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the opening device (e.g., 430 in FIGS. 1, 2, 3A to 3C, 4, 5, 6A, 6B, 7, 8A to 8C, 9A to 9C, 10 to 15, 16A, 16B, 17, and 18) may include a first opening member (e.g., 431 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the opening device (e.g., 430 in FIGS. 1, 2, 3A to 3C, 4, 5, 6A, 6B, 7, 8A to 8C, 9A to 9C, 10 to 15, 16A, 16B, 17, and 18) may include a second opening member (e.g., 432 in FIGS. 1, 2, 3A to 3C, 4, 5, 6A, 6B, 7, 8A to 8C, 9A to 9C, 10 to 15, 16A, 16B, 17, and 18) spaced apart from the first opening member (e.g., 431 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the opening device (e.g., 430 in FIGS. 1, 2, 3A to 3C, 4, 5, 6A, 6B, 7, 8A to 8C, 9A to 9C, 10 to 15, 16A, 16B, 17, and 18) may operate in one of a first state, in which a first gap is formed between the first opening member (e.g., 431 in FIGS. 1, 2, 3A to 3C, 4, 5, 6A, 6B, 7, 8A to 8C, 9A to 9C, 10 to 15, 16A, 16B, 17, and 18) and the second opening member (e.g., 432 in FIGS. 1, 2, 3A to 3C, 4, 5, 6A, 6B, 7, 8A to 8C, 9A to 9C, 10 to 15, 16A, 16B, 17, and 18), and a second state, in which a second gap smaller than the first gap is formed between the first opening member (e.g., 431 in FIGS. 1, 2, 3A to 3C, 4, 5, 6A, 6B, 7, 8A to 8C, 9A to 9C, 10 to 15, 16A, 16B, 17, and 18) and the second opening member (e.g., 432 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the opening device (e.g., 430 in FIGS. 1, 2, 3A to 3C, 4, 5, 6A, 6B, 7, 8A to 8C, 9A to 9C, 10 to 15, 16A, 16B, 17, and 18) may operate according to one of an electrostatic actuation method, an electromagnetic actuation method, or a piezoelectric actuation method.

According to an embodiment of the disclosure, the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include a tuning device (e.g., 483 in FIGS. 1, 2, 3A to 3C, 4, 5, 6A, 6B, 7, 8A to 8C, 9A to 9C, 10 to 15, 16A, 16B, 17, and 18) configured to tune sound output through the speaker (e.g., 390 in FIGS. 1, 2, 3A to 3C, 4, 5, 6A, 6B, 7, 8A to 8C, 9A to 9C, 10 to 15, 16A, 16B, 17, and 18) after the opening device (e.g., 430 in FIGS. 1, 2, 3A to 3C, 4, 5, 6A, 6B, 7, 8A to 8C, 9A to 9C, 10 to 15, 16A, 16B, 17, and 18) is controlled.

According to an embodiment of the disclosure, a method for operating a wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include an operation of outputting sound through a speaker (e.g., 390 in FIGS. 1, 2, 3A to 3C, 4, 5, 6A, 6B, 7, 8A to 8C, 9A to 9C, 10 to 15, 16A, 16B, 17, and 18) while an acoustic passage (e.g., 420 in FIGS. 1, 2, 3A to 3C, 4, 5, 6A, 6B, 7, 8A to 8C, 9A to 9C, 10 to 15, 16A, 16B, 17, and 18) formed inside a housing (e.g., 310 in FIGS. 1, 2, 3A to 3C, 4, 5, 6A, 6B, 7, 8A to 8C, 9A to 9C, 10 to 15, 16A, 16B, 17, and 18) accommodating the speaker (e.g., 390 in FIGS. 1, 2, 3A to 3C, 4, 5, 6A, 6B, 7, 8A to 8C, 9A to 9C, 10 to 15, 16A, 16B, 17, and 18) is opened.

According to an embodiment of the disclosure, a method for operating the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include an operation of sensing information about sound received through a microphone (e.g., 440 in FIGS. 1, 2, 3A to 3C, 4, 5, 6A, 6B, 7, 8A to 8C, 9A to 9C, 10 to 15, 16A, 16B, 17, and 18) disposed inside the housing (e.g., 310 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, a method for operating the wearable electronic device (e.g., 300 in FIGS. 1, 2, 3A to 3C, 4, 5, 6A, 6B, 7, 8A to 8C, 9A to 9C, 10 to 15, 16A, 16B, 17, and 18) may include an operation of controlling an opening device (e.g., 430 in FIGS. 1, 2, 3A to 3C, 4, 5, 6A, 6B, 7, 8A to 8C, 9A to 9C, 10 to 15, 16A, 16B, 17, and 18) configured to close the acoustic passage (e.g., 321 in FIGS. 1, 2, 3A to 3C, 4, 5, 6A, 6B, 7, 8A to 8C, 9A to 9C, 10 to 15, 16A, 16B, 17, and 18), based on the information about the sound received through the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the operation of controlling the opening device (e.g., 430 in FIGS. 1, 2, 3A to 3C, 4, 5, 6A, 6B, 7, 8A to 8C, 9A to 9C, 10 to 15, 16A, 16B, 17, and 18) may include an operation of adjusting the opening degree of the acoustic passage (e.g., 420 in FIGS. 1, 2, 3A to 3C, 4, 5, 6A, 6B, 7, 8A to 8C, 9A to 9C, 10 to 15, 16A, 16B, 17, and 18), based on the level of howling included in the sound received through the microphone (e.g., 440 in FIGS. 1, 2, 3A to 3C, 4, 5, 6A, 6B, 7, 8A to 8C, 9A to 9C, 10 to 15, 16A, 16B, 17, and 18).

According to an embodiment of the disclosure, the operation of controlling the opening device (e.g., 430 in FIGS. 1, 2, 3A to 3C, 4, 5, 6A, 6B, 7, 8A to 8C, 9A to 9C, 10 to 15, 16A, 16B, 17, and 18) may include an operation of closing the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) when the howling is included in the sound received through the microphone (e.g., 440 in FIGS. 1, 2, 3A to 3C, 4, 5, 6A, 6B, 7, 8A to 8C, 9A to 9C, 10 to 15, 16A, 16B, 17, and 18), and opening the acoustic passage (e.g., 420 in FIGS. 1, 2, 3A to 3C, 4, 5, 6A, 6B, 7, 8A to 8C, 9A to 9C, 10 to 15, 16A, 16B, 17, and 18) when the howling is not included in the sound received through the microphone (e.g., 440 in FIGS. 1, 2, 3A to 3C, 4, 5, 6A, 6B, 7, 8A to 8C, 9A to 9C, 10 to 15, 16A, 16B, 17, and 18).

Although the detailed description of the disclosure has been made with respect to specific embodiments, it will be apparent to those skilled in the art that various modifications are possible without departing from the scope of the disclosure.

While the disclosure has been shown and described with reference to various embodiments thereof, it will be understood by those skilled in the art that various changes in form and details made be made therein without departing from the spirit and scope of the disclosure as defined by the appended claims and their equivalents.

What is claimed is:

1. A wearable electronic device comprising:
a speaker;
a microphone spaced apart from the speaker;
a housing accommodating the speaker and the microphone, and including an output passage configured to transfer a sound output from the speaker and a sound passage configured to transfer a sound received by the microphone;
an opening device configured to close or open at least a portion of the sound passage;
a detecting device configured to sense information related to the sound received by the microphone;
at least one processor; and
memory storing instructions configured to, when executed by the at least one processor individually or collectively, cause the wearable electronic device to:
control the opening device based on the information sensed by the detecting device.

2. The wearable electronic device of claim 1, wherein the information sensed by the detecting device is information related to howling included in the sound received by the microphone.

3. The wearable electronic device of claim 2, wherein the detecting device is configured to identify generation of the howling based on a wave of the sound received by the microphone.

4. The wearable electronic device of claim 1, wherein the detecting device includes:
a sensing device configured to sense a wave of the sound received by the microphone; and
a detector configured to identify generation of howling based on the wave sensed by the sensing device.

5. The wearable electronic device of claim 1, wherein the instructions are configured to, when executed by the at least one processor individually or collectively, further cause the wearable electronic device to:
control the opening device to control an opening level of the sound passage based on the information sensed by the detecting device.

6. The wearable electronic device of claim 1, wherein the instructions are configured to, when executed by the at least one processor individually or collectively, further cause the wearable electronic device to:
control the opening device to close the sound passage when howling is included in the sound received by the microphone; and
control the opening device to open the sound passage when howling is not included in the sound received by the microphone.

7. The wearable electronic device of claim 1, wherein the instructions are configured to, when executed by the at least one processor individually or collectively, further cause the wearable electronic device to:
control the opening device to control an opening level of the sound passage according to a level of howling included in the sound received by the microphone.

8. The wearable electronic device of claim 1, wherein the instructions are configured to, when executed by the at least one processor individually or collectively, further cause the wearable electronic device to:
operate in one of a first mode where the sound passage operates in an open state and a second mode where the sound passage operates in a closed state.

9. The wearable electronic device of claim 8, wherein the instructions are configured to, when executed by the at least one processor individually or collectively, further cause the wearable electronic device to:
control the opening device such that the sound passage is opened when a mode of the wearable electronic device is changed from the second mode to the first mode.

10. The wearable electronic device of claim 1,
wherein the housing includes an opening communicated with an outside of the housing, and
wherein the sound passage extends from the opening toward the output passage.

11. The wearable electronic device of claim 1, wherein the sound passage includes:
a passage formed inside the housing toward the output passage; and
a channel connected to the passage and configured to be closable by the opening device.

12. The wearable electronic device of claim 11,
wherein the housing includes an opening communicated with an outside of the housing, and
wherein the sound passage includes:
a first passage connecting the opening and the passage, and
a second passage connecting the channel and the output passage.

13. The wearable electronic device of claim 1,
wherein the opening device comprises:
a first opening member, and
a second opening member spaced apart from the first opening member, and
wherein the opening device is configured to operate in one of a first state in which a first gap is formed between the first opening member and the second opening member and a second state in which a second gap smaller than the first gap is formed between the first opening member and the second opening member.

14. The wearable electronic device of claim 1, wherein the opening device is configured to operate in one of an electrostatic actuation method, an electromagnetic actuation method or a piezoelectric actuation method.

15. The wearable electronic device of claim 1, further comprising:
a tuning device configured to tune a sound output from the speaker after the opening device is controlled.
